(19) United States
(12) Patent Application Publication
(10) Pub. No.: US 2004/0121793 A1
(43) Pub. Date: Jun. 24, 2004

(54) Methods and apparatus for controlling power to electrical circuitry of a wireless communication device having a subscriber identity module (SIM) interface

(76) Inventors: Ingo W. Weigele, Waterloo (CA); Joseph T. Deu-Ngoc, Waterloo (CA)

Correspondence Address: David B. Cochran, Esq., JONES DAY, North Point, 901 Lakeside Ave., Cleveland, OH, 44114, US

(21) Appl. No.: 10/427,015

(22) Filed: Apr. 30, 2003

Related U.S. Application Data
(60) Provisional application No. 60/435,862, filed on Dec. 24, 2002.

(51) Int. Cl. H04B 7/00; H04Q 7/20

(52) U.S. Cl. 455/522

(57) ABSTRACT

Methods and apparatus for controlling power to electrical circuitry of a wireless communication device having a Subscriber Identity Module (SIM) interface are described. In one illustrative embodiment, a method includes the acts of receiving a power down signal from a user interface of the wireless communication device; powering down radio frequency (RF) transceiver circuitry of the wireless communication device in response to the power down signal; and maintaining power to a SIM interface of the wireless communication device while the RF transceiver circuitry is powered down from the power down signal. A visual display of the device is capable of displaying information (e.g. address book information) from a SIM card while the RF transceiver circuitry is powered down from the power down signal.

### CROSS-REFERENCE TO RELATED APPLICATION

The present application claims priority to U.S. Provisional Application No. 60/435,862 filed on Dec. 24, 2002, the contents of which are incorporated herein, by reference, in their entirety.

### BACKGROUND

1. Field of the Technology

The present application relates generally to wireless communication devices, and relates more particularly to controlling power to electrical circuitry of a wireless communication device having a Subscriber Identity Module (SIM) interface.

2. Description of the Problem

Minimizing power consumption of battery-operated portable wireless communication devices, such as mobile stations operating in cellular telecommunication networks, is a relatively important objective. Such devices typically include a radio frequency (RF) transceiver for communications and provide one or more functions for an end user, such as telephone, e-mail, text messaging, calendaring/scheduling, and other organizing applications. The e-mail, calendaring, and/or organizing capabilities in the wireless device may be provided with a wireless synchronizing capability with a remote computer or other device.

Such devices typically include manual switches to power the device ON or OFF in its entirety. With an ON/OFF switch, the battery of the device can be conserved when the device is not needed for direct use by the end user. Recently, devices have been becoming more multi-functional in nature, providing for more than one of the above functions, for example. Some of these devices are known to provide manual switches to place them into an intermediate ON/OFF state where the wireless capability is powered down but some other portions of the circuitry (e.g. the microprocessor) are still generally active. Here, an end user can utilize other applications on the device (e.g. a local calendaring application) when the RF transceiver is not needed. However, devices having this capability do not utilize a Subscriber Identify Module (SIM) interface in connection therewith.

Some wireless devices operate using a SIM which is connected to or inserted into the device at its SIM interface. A SIM is one type of a conventional “smart card” used to identify an end user (or subscriber) of the wireless device and to personalize the device, among other things. It generally includes a processor and memory for storing information. Without a SIM, some wireless devices are not fully operational for communicating through particular wireless networks. By inserting a SIM into the device, an end user can have access to any and all of his/her subscribed services. To identify the subscriber, a SIM typically contains some user parameters such as an International Mobile Subscriber Identity (IMSI). In addition, a SIM is typically protected by a four-digit Personal Identification Number (PIN) which is stored therein and known only by the end user. An advantage of using the SIM is that end users are not necessarily bound by any single physical wireless device. Typically, the only element that personalizes a wireless device terminal is a SIM card. Therefore, the user can access subscribed services using any wireless device equipped to operate with the user's SIM.

Accordingly, there is a need for alternative methods and apparatus for controlling power to electrical circuitry of a wireless communication device having a SIM interface, especially in a multi-functional device.

### SUMMARY

Methods and apparatus for controlling power to electrical circuitry of a wireless communication device having a Subscriber Identify Module (SIM) interface are described. In one illustrative example, a method includes the acts of receiving a power down signal from a user interface of the wireless communication device; powering down radio frequency (RF) transceiver circuitry of the wireless communication device in response to the power down signal; and maintaining power to a SIM interface of the wireless communication device while the RF transceiver circuitry is powered down from the power down signal. Advantageously, an end user of the wireless device may access stored information on a SIM while the wireless device is kept in this low power state with its RF transceiver circuitry being powered down.

### BRIEF DESCRIPTION OF THE DRAWINGS

Embodiments of present invention will now be described by way of example with reference to attached figures, wherein:

FIG. 1 is a block diagram of a communication system which includes a wireless communication device for communicating in a wireless communication network, where the wireless communication device includes a smart card interface such as a Subscriber Identity Module (SIM) interface;

FIG. 2 is an illustration of the wireless communication network having the wireless communication device operating therein for communicating data between one or more application servers through a public or private communication network;

FIG. 3 is a particular structure of a system for communication with the wireless communication device;

FIG. 4 is a more detailed example of a wireless communication device which has a smart card interface (e.g. a SIM interface);

FIG. 5 is a state transition diagram for the wireless communication device of FIG. 1 or FIG. 4; and

FIG. 6 is a flowchart which describes a method of controlling power to circuitry of the wireless communication device of FIG. 1 or FIG. 4.

### DETAILED DESCRIPTION OF THE PREFERRED EMBODIMENTS

Broadly, a power down signal is received from a user interface of a wireless communication device. In response, radio frequency (RF) transceiver circuitry of the wireless device is powered down. However, power is maintained to a SIM interface of the wireless device while the RF transceiver circuitry is powered down from the power down signal. Advantageously, an end user of the wireless device may access stored information on a SIM while the wireless device is kept in the low power state with its RF transceiver circuitry powered down. Further advantageous implementation details are described below.

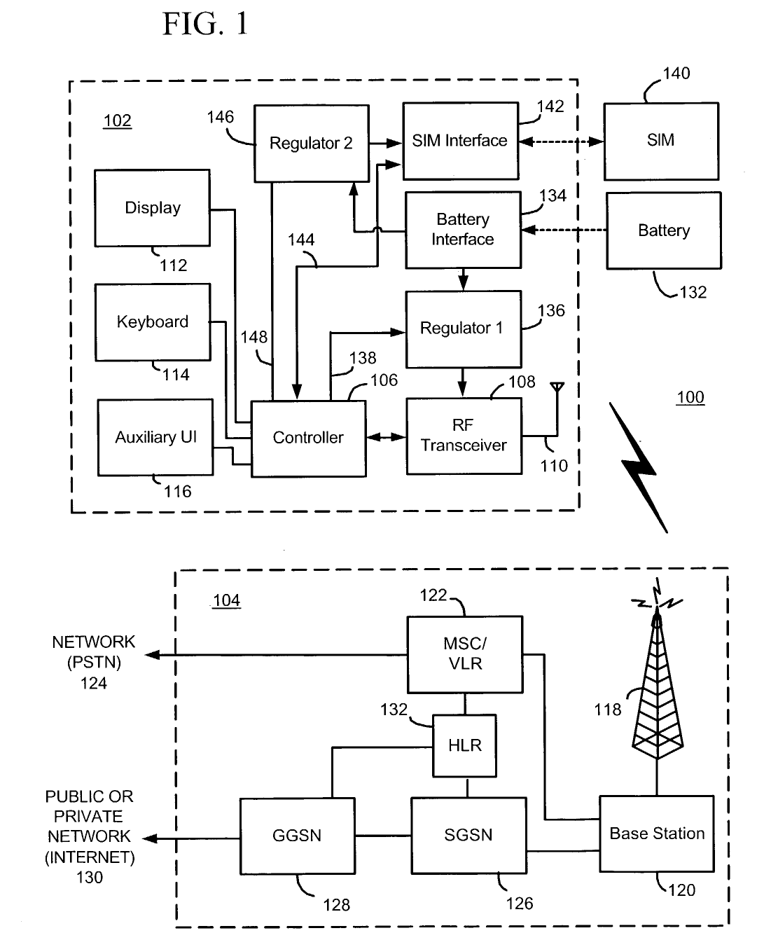

FIG. 1 is a block diagram of a communication system 100 which includes a wireless communication device 102 which communicates through a wireless communication network 104. Wireless communication device 102 preferably includes a visual display 112, a keyboard 114, and perhaps one or more auxiliary user interfaces (UT) 116, each of which are coupled to a controller 106. Controller 106 is also coupled to radio frequency (RF) transceiver circuitry 108 and an antenna 110.

In most modern communication devices, controller 106 is embodied as a central processing unit (CPU) which runs operating system software in a memory component (not shown). Controller 106 will normally control overall operation of wireless device 102, whereas signal processing operations associated with communication functions are typically performed in RF transceiver circuitry 108. Controller 106 interfaces with device display 112 to display received information, stored information, user inputs, and the like. Keyboard 114, which may be a telephone type keypad or full alphanumeric keyboard, is normally provided for entering data for storage in wireless device 102, information for transmission to network 104, a telephone number to place a telephone call, commands to be executed on wireless device 102, and possibly other or different user inputs.

Wireless device 102 sends communication signals to and receives communication signals from network 104 over a wireless link via antenna 110. RF transceiver circuitry 108 performs functions similar to those of base station 120, including for example modulation/demodulation and possibly encoding/decoding and encryption/decryption. It is also contemplated that RF transceiver circuitry 108 may perform certain functions in addition to those performed by base station 120. It will be apparent to those skilled in art that RF transceiver circuitry 108 will be adapted to particular wireless network or networks in which wireless device 102 is intended to operate.

When wireless device 102 is fully operational, an RF transmitter of RF transceiver circuitry 108 is typically keyed or turned on only when it is sending to network, and is otherwise turned off to conserve resources. Such intermittent operation of transmitter has a dramatic effect on power consumption of wireless device 102. Since power of wireless device 102 is normally provided by a limited power source, such as a rechargeable battery, device design and operation must minimize power consumption in order to extend battery life or time between power source charging operations. Similarly, an RF receiver of RF transceiver circuitry 108 is typically periodically turned off to conserve power until it is needed to receive signals or information (if at all) during designated time periods.

Wireless device 102 operates using a Subscriber Identity Module (SIM) which is connected to or inserted in wireless device 102 at a SIM interface 142. SIM 140 is one type of a conventional “smart card” used to identify an end user (or subscriber) of wireless device 102 and to personalize the device, among other things. Without SIM 140, the wireless device terminal is not fully operational for communication through wireless network 104. By inserting SIM 140 into wireless device 102, an end user can have access to any and all of his/her subscribed services. In order to identify the subscriber, SIM 140 contains some user parameters such as an International Mobile Subscriber Identity (IMSI). In addition, SIM 140 is typically protected by a four-digit Personal Identification Number (PIN) which is stored therein and known only by the end user. An advantage of using SIM 140 is that end users are not necessarily bound by any single physical wireless device. Typically, the only element that personalizes a wireless device terminal is a SIM card. Therefore, the user can access subscribed services using any wireless device equipped to operate with the user's SIM.

SIM and interfacing standards are well-known and defined, for example, in GSM 11.11 (SIM protocols), ISO/IEC 7816-1 (physical characteristics), ISO/IEC 7816-2 (dimensions and locations of contacts), and ISO/IEC 7816-3 (electronic signals and transmission protocols). SIM 140 generally includes a processor and memory for storing information. For interfacing with a standard GSM device having SIM interface 142, a conventional SIM 140 has six (6) connections. A typical SIM 140 stores all of the following information: (1) an International Mobile Subscriber Identity (IMSI); (2) an individual subscriber's authentication key (Ki); (3) a ciphering key generating algorithm (A8)—with Ki and RAND it generates a 64-bit key (Kc); (4) an authentication algorithm (A3)—with Ki and RAND it generates a 32-bit signed response (SRED); (5) a user PIN code (1 & 2); (6) a PUK code (1 & 2) (this is also referred to as the SPIN); (7) a user phone book; (8) stored Short Message Service (SMS) messages; and (9) a preferred network list. SIM 140 may store additional user information for the wireless device as well, including datebook (or calendar) information and recent call information. As apparent, some of the information stored on SIM 140 (e.g. address book information and SMS messages) is initially received at wireless device 102 over wireless network 104 through its RF transceiver circuitry 108, or received from the end user through keyboard 114.

Another type of smart card is used in connection with a Universal Mobile Telecommunications System (UMTS) standard. The UMTS standard does not restrict the functionality of the wireless device equipment in any way. Wireless device terminals operate as the “air interface” and can have many different types of identities. Most of the UMTS identity types are borrowed directly from GSM specifications: (1) an International Mobile Subscriber Identity (IMSI); (2) a Temporary Mobile Subscriber Identity (TMSI); (3) a Packet Temporary Mobile Subscriber Identity (P-TMSI); (4) a Temporary Logical Link Identity (TLLI); (5) a mobile station ISDN (MSISDN); (5) an International Mobile Station Equipment Identity (IMEI); and (6) an International Mobile Station Equipment Identity and Software Number (IMEISV). A UMTS card has same physical characteristics as a GSM SIM card. The UMTS card has several functions: (1) to support of one User Service Identity Module (USIM) application (optionally more than one); (2) to support of one or more user profiles on the USIM; (3) update USIM specific information over-the-air; (4) to provide security functions; (5) to provide user authentication; (6) to optionally provide for payment methods; and (7) to optionally provide for the secure downloading of new applications.

Some information stored on SIM 140 (e.g. address book and SMS messages) may be retrieved and visually displayed on display 112. Wireless device 102 has one or more software applications which are executed by controller 144 to facilitate the information stored on SIM 140 to be displayed on display 112. Controller 144 and SIM interface 142 have data and control lines 144 coupled therebetween to facilitate the transfer of the information between controller 144 and SIM interface 142 so that it may be visually displayed. An end user enters user input signals at keyboard 114, for example, and in response, controller 144 controls SIM interface 142 and SIM 140 to retrieve the information for display. The end user may also enter user input signals at keyboard 114, for example, and, in response, controller 144 controls SIM interface 142 and SIM 140 to store information on SIM 140 for later retrieval and viewing. Preferably, the software applications executed by controller 106 include an application to retrieve and display address book information stored on SIM 140, and an application to retrieve and display SMS message information stored on SIM 140.

Wireless device 102 includes a battery interface 134 for receiving one or more rechargeable batteries 132. Battery 132 provides electrical power to (most if not all) electrical circuitry in wireless device 102, and battery interface 132 provides for a mechanical and electrical connection for battery 132. Battery interface 132 is coupled to a regulator 136 which regulates power to RF transceiver circuitry 108. Battery interface 134 is also coupled to a separate regulator 146 which regulates power to SIM interface 142 of wireless device 102. Regulator 146 may be the same regulator used to regulate power to most of the remaining circuitry of wireless device 102 (e.g. controller 106 and the user interface). Controller 106 is coupled to regulator 136 via a control line 138 to enable or disable power to RF transceiver circuitry 108. Similarly, controller 106 is coupled to regulator 146 via a control line 148 to enable or disable power to SIM interface 142. Alternatively, line 148 is not such a control line, but rather is a line which supplies power to both SIM interface 142 and controller 106 (and any other necessary circuitry).

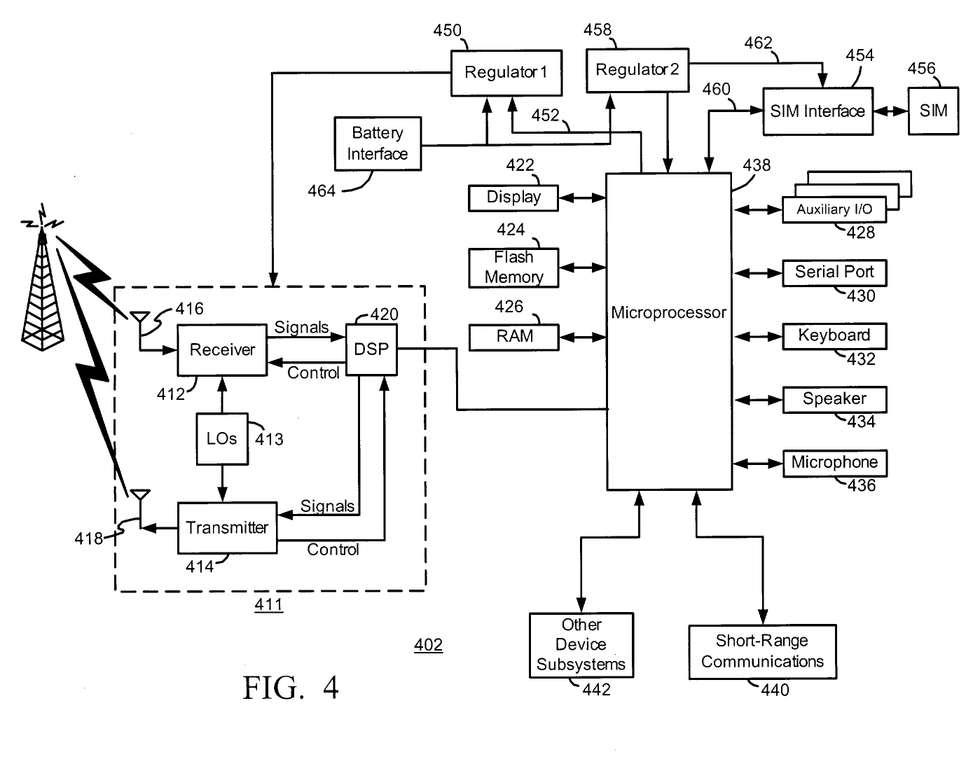

As apparent from the above, the term “wireless device” is used herein in reference to a wireless mobile communication device. In the embodiment of FIG. 1, wireless device 102 is referred to as mobile equipment which, when used with SIM 140, is referred to as a mobile station. Wireless device 102 may consist of a single unit, such as a data communication device, a cellular telephone, a multiple-function communication device with data and voice communication capabilities, a personal digital assistant (PDA) enabled for wireless communication, or a computer incorporating an internal modem. Alternatively, wireless device 102 may be a multiple-module unit comprising a plurality of separate components, including but in no way limited to a computer or other device connected to a wireless modem. In particular, for example, in the wireless device block diagram of FIG. 1, RF transceiver circuitry 108 and antenna 110 may be implemented as a radio modem unit that may be inserted into a port on a laptop computer. In this case, the laptop computer would include display 112, keyboard 114, one or more auxiliary UIs 116, and controller 106 embodied as the computer's CPU. It is also contemplated that a computer or other equipment not normally capable of wireless communication may be adapted to connect to and effectively assume control of RF transceiver circuitry 108 and antenna 110 of a singleunit device such as one of those described above. Such a wireless device 102 may have a more particular implementation as described later in relation to wireless device 402 of FIG. 4.

Wireless device 102 communicates in and through wireless communication network 104. In the embodiment of FIG. 1, wireless network 104 is a Global Systems for Mobile (GSM) and General Packet Radio Service (GPRS) network. Wireless network 104 includes a base station 120 with an associated antenna tower 118, a Mobile Switching Center (MSC) 122, a Home Location Register (HLR) 132, a Serving General Packet Radio Service (GPRS) Support Node (SGSN) 126, and a Gateway GPRS Support Node (GGSN) 128. MSC 122 is coupled to base station 120 and to a landline network, such as a Public Switched Telephone Network (PSTN) 124. SGSN 126 is coupled to base station 120 and to GGSN 128, which is in turn coupled to a public or private data network 130 (such as the Internet). HLR 132 is coupled to MSC 122, SGSN 126, and GGSN 128.

Base station 120, including its associated controller and antenna tower 118, provides wireless network coverage for a particular coverage area commonly referred to as a “cell”. Base station 120 transmits communication signals to and receives communication signals from wireless devices within its cell via antenna tower 118. Base station 120 normally performs such functions as modulation and possibly encoding and/or encryption of signals to be transmitted to the wireless device in accordance with particular, usually predetermined, communication protocols and parameters, under control of its controller. Base station 120 similarly demodulates and possibly decodes and decrypts, if necessary, any communication signals received from wireless device 102 within its cell. Communication protocols and parameters may vary between different networks. For example, one network may employ a different modulation scheme and operate at different frequencies than other networks.

The wireless link shown in communication system 100 of FIG. 1 represents one or more different channels, typically different radio frequency (RF) channels, and associated protocols used between wireless network 104 and wireless device 102. An RF channel is a limited resource that must be conserved, typically due to limits in overall bandwidth and a limited battery power of wireless device 102. Those skilled in art will appreciate that a wireless network in actual practice may include hundreds of cells, each served by a distinct base station 120 and transceiver, depending upon desired overall expanse of network coverage. All base station controllers and base stations may be connected by multiple switches and routers (not shown), controlled by multiple network controllers.

For all wireless device's 102 registered with a network operator, permanent data (such as wireless device 102 user's profile) as well as temporary data (such as wireless device's 102 current location) are stored in HLR 132. In case of a voice call to wireless device 102, HLR 132 is queried to determine the current location of wireless device 102. A Visitor Location Register (VLR) of MSC 122 is responsible for a group of location areas and stores the data of those wireless devices that are currently in its area of responsibility. This includes parts of the permanent wireless device data that have been transmitted from HLR 132 to the VLR for faster access. However, the VLR of MSC 122 may also assign and store local data, such as temporary identifications. Optionally, the VLR of MSC 122 can be enhanced for more efficient co-ordination of GPRS and non-GPRS services and functionality (e.g. paging for circuit-switched calls which can be performed more efficiently via SGSN 126, and combined GPRS and non-GPRS location updates).

Being part of the GPRS network, Serving GPRS Support Node (SGSN) 126 is at the same hierarchical level as MSC 122 and keeps track of the individual locations of wireless devices. SGSN 126 also performs security functions and access control. Gateway GPRS Support Node (GGSN) 128 provides interworking with external packet-switched networks and is connected with SGSNs (such as SGSN 126) via an IP-based GPRS backbone network. SGSN 126 performs authentication and cipher setting procedures based on the same algorithms, keys, and criteria as in existing GSM. In conventional operation, cell selection may be performed autonomously by wireless device 102 or by base station 120 instructing wireless device 102 to select a particular cell. Wireless device 102 informs wireless network 104 when it reselects another cell or group of cells, known as a routing area.

In order to access GPRS services, wireless device 102 first makes its presence known to wireless network 104 by performing what is known as a GPRS “attach”. This operation establishes a logical link between wireless device 102 and SGSN 126 and makes wireless device 102 available to receive, for example, pages via SGSN, notifications of incoming GPRS data, or SMS messages over GPRS. In order to send and receive GPRS data, wireless device 102 assists in activating the packet data address that it wants to use. This operation makes wireless device 102 known to GGSN 128; interworking with external data networks can thereafter commence. User data may be transferred transparently between wireless device 102 and the external data networks using, for example, encapsulation and tunneling. Data packets are equipped with GPRS-specific protocol information and transferred between wireless device 102 and GGSN 128.

As apparent from the above, the term “network” is used herein to denote fixed portions of the network, including RF transceivers, amplifiers, base station controllers, network servers, and servers connected to network. Those skilled in art will appreciate that a wireless network may be connected to other systems, possibly including other networks, not explicitly shown in FIG. 1. A network will normally be transmitting at very least some sort of paging and system information on an ongoing basis, even if there is no actual packet data exchanged. Although the network consists of many parts, these parts all work together to result in certain behaviours at the wireless link.

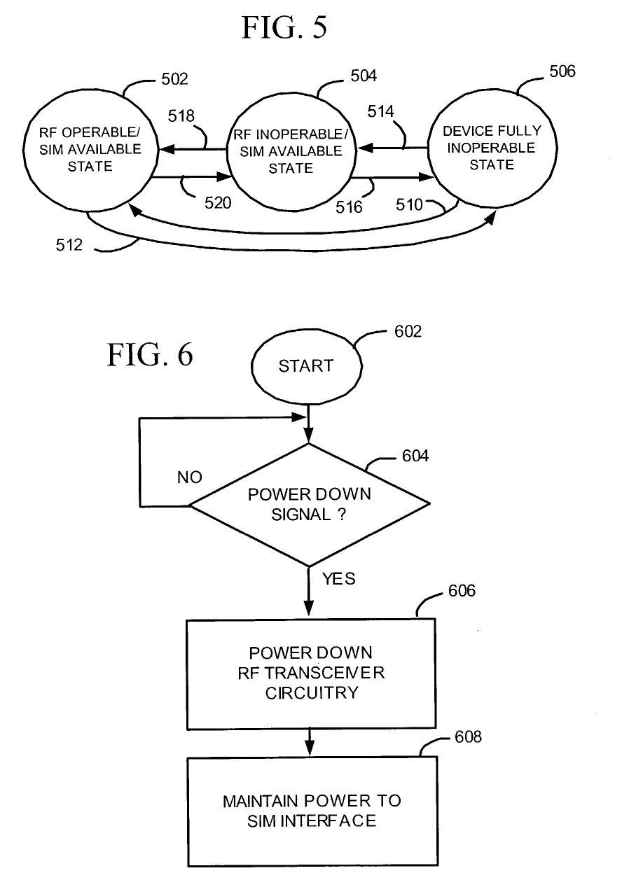

The above described electrical configuration for wireless device 102 may be used to operate wireless device 102 as follows. In a first operational state of wireless device 102, wireless device 102 is fully operative where regulators 136 and 146 are enabled and supplying power to RF transceiver circuitry 108 and SIM interface 142, respectively. In a second operational state of wireless device 102, wireless device 102 is only partially operative where regulator 136 is disabled by controller 106 so that RF transceiver circuitry 108 is powered off or shut down. However, regulator 146 continues to be operative and supply power to SIM interface 142 (and perhaps controller 106 and the user interface). No wireless or RE communication is possible in the second operational state, but wireless device 102 consumes less power compared to the first operational state. In a non-operational state of wireless device 102, (most if not) all electrical circuitry of wireless device 102 including RF transceiver circuitry 108, SIM interface 142, and controller 106 are powered down. These state transitions may be controlled by the end user at the user interface. The above operation of wireless device 102 is described in more detail later in relation to FIG. 5.

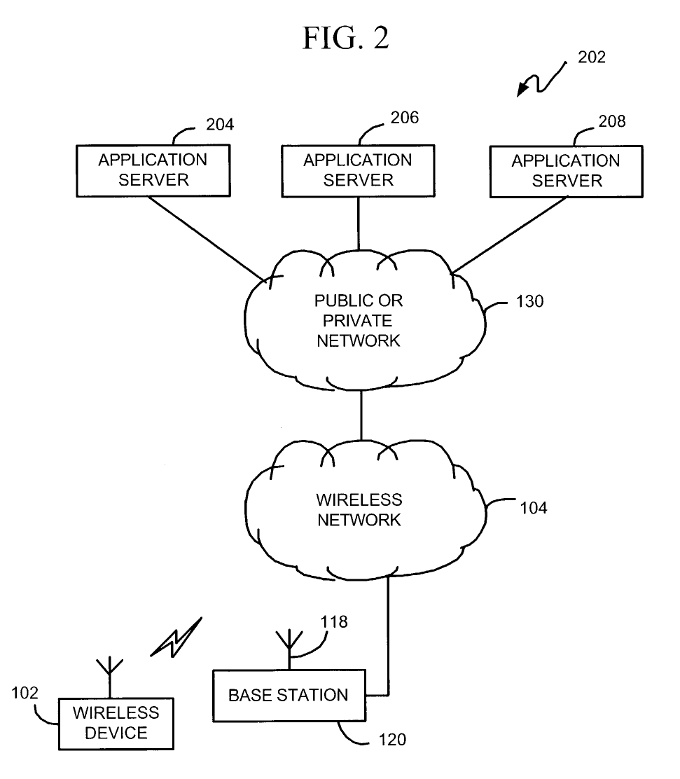

FIG. 2 is a simplified illustration of wireless network 104 having wireless device 102 operating therein for communicating data between one or more application servers 202 through a public or private communication network 130. Network 130 may be or include Internet, and include a serving network to facilitate the communication of information between application servers 202 and wireless device 102. There are three application servers 202 shown in FIG. 2, namely, application servers 204, 206, and 208; however any suitable number of application servers may be employed in the network. Application servers 202 may provide any suitable voice and/or data service(s) for wireless device 102, especially “push”-based services. More specifically, application servers 202 may provide an electronic mail (e-mail) service, a wireless application protocol (WAP) service, a short messaging service (SMS) service, or an applicationspecific service such as a weather update service, a horoscope service, and a stock market quotation service, as a few examples. Some of this information, as well as other types of information, may be stored on SIM 140 (FIG. 1) of wireless device 102 after being received by RF transceiver circuitry 108 (FIG. 1) and is retrievable as described above in relation to FIG. 1 and FIG. 5 as described below.

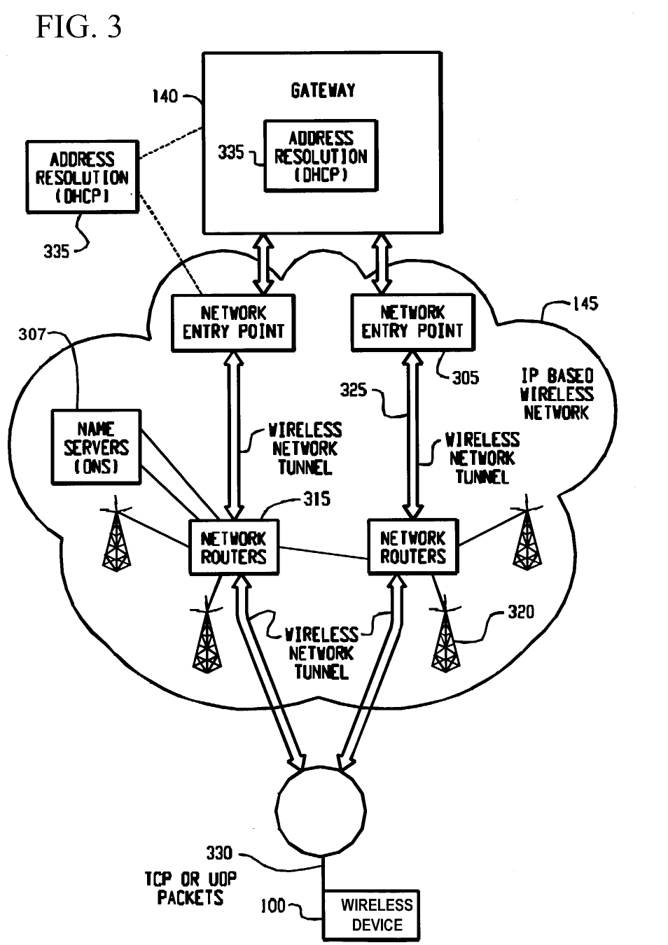

FIG. 3 shows a particular system structure for communicating with a wireless communication device. In particular, FIG. 3 shows basic components of an IP-based wireless data network, such as a GPRS network. A wireless device 100 communicates with a wireless packet data network 145, and may also be capable of communicating with a wireless voice network (not shown). Preferably, wireless network 145 provides for “push”-based services to wireless device 100 and other similar devices. Wireless device 100 of FIG. 3 may be wireless device 102 of FIGS. 1 and 2. The voice network may be associated with IP-based wireless network 145 similar to, for example, GSM and GPRS networks, or alternatively may be a completely separate network. The GPRS IP-based data network is unique in that it is effectively an overlay on the GSM voice network. As such, GPRS components will either extend existing GSM components, such as base stations 320, or require additional components to be added, such as an advanced Gateway GPRS Service Node (GGSN) as a network entry point 305.

As shown in FIG. 3, a gateway 140 may be coupled to an internal or external address resolution component 335 and one or more network entry points 305. Data packets are transmitted from gateway 140, which is source of information to be transmitted to wireless device 100, through network 145 by setting up a wireless network tunnel 325 from gateway 140 to wireless device 100. In order to create this wireless tunnel 325, a unique network address is associated with wireless device 100. In an IP-based wireless network, however, network addresses are normally not permanently assigned to a particular wireless device 100 but instead are dynamically allocated on an as-needed basis. It is thus preferable for wireless device 100 to acquire a network address and for gateway 140 to determine this address so as to establish wireless tunnel 325.

Network entry point 305 is generally used to multiplex and demultiplex amongst many gateways, corporate servers, and bulk connections such as the Internet, for example. There are normally very few of these network entry points 305, since they are also intended to centralize externally available wireless network services. Network entry points 305 often use some form of an address resolution component 335 that assists in address assignment and lookup between gateways and wireless devices. In this example, address resolution component 335 is shown as a dynamic host configuration protocol (DHCP) as one method for providing an address resolution mechanism.

A central internal component of wireless data network 345 is a network router 315. Normally, network routers 315 are proprietary to the particular network, but they could alternatively be constructed from standard commercially available hardware. The purpose of network routers 315 is to centralize thousands of base stations 320 normally implemented in a relatively large network into a central location for a long-haul connection back to network entry point 305. In some networks there may be multiple tiers of network routers 315 and cases where there are master and slave network routers 315, but in all such cases the functions are similar. Often network router 315 will access a name server 307, in this case shown as a dynamic name server (DNS) 307 as used in the Internet, to look up destinations for routing data messages. Base stations 320, as described above, provide wireless links to wireless devices such as wireless device 100.

Wireless network tunnels such as a wireless tunnel 325 are opened across wireless network 345 in order to allocate necessary memory, routing, and address resources to deliver IP packets. In GPRS, such tunnels 325 are established as part of what are referred to as “PDP contexts” (i.e. data sessions). To open wireless tunnel 325, wireless device 100 must use a specific technique associated with wireless network 345. The step of opening such a wireless tunnel 325 may require wireless device 100 to indicate the domain, or network entry point 305 with which it wishes to open wireless tunnel 325. In this example, the tunnel first reaches network router 315 which uses name server 307 to determine which network entry point 305 matches the domain provided. Multiple wireless tunnels can be opened from one wireless device 100 for redundancy, or to access different gateways and services on the network. Once the domain name is found, the tunnel is then extended to network entry point 305 and necessary resources are allocated at each of the nodes along the way. Network entry point 305 then uses the address resolution (or DHCP 335) component to allocate an IP address for wireless device 100. When an IP address has been allocated to wireless device 100 and communicated to gateway 140, information can then be forwarded from gateway 140 to wireless device 100.

Wireless tunnel 325 typically has a limited life, depending on wireless device's 100 coverage profile and activity. Wireless network 145 will tear down wireless tunnel 325 after a certain period of inactivity or out-of-coverage period, in order to recapture resources held by this wireless tunnel 325 for other users. The main reason for this is to reclaim the IP address temporarily reserved for wireless device 100 when wireless tunnel 325 was first opened. Once the IP address is lost and wireless tunnel 325 is torn down, gateway 140 loses all ability to initiate IP data packets to wireless device 100, whether over Transmission Control Protocol (TCP) or over User Datagram Protocol (UDP).

In this application, the expression “IP-based wireless network” is intended to include, but is not limited to: (1) Code Division Multiple Access (CDMA) network that has been developed and operated by Qualcomm; (2) General Packet Radio Service (GPRS) for use in conjunction with Global System for Mobile Communications (GSM) network both developed by standards committee of European Conference of Postal and Telecommunications Administrations (CEPT); and (3) future third-generation (3G) networks like Enhanced Data rates for GSM Evolution (EDGE) and Universal Mobile Telecommunications System (UMTS). GPRS is a data communications overlay on top of GSM wireless network. It is to be understood that although particular IP-based wireless networks have been described, the communication re-establishment schemes of the present application could be utilized in any suitable type of wireless packet data network.

FIG. 4 is a detailed block diagram of a wireless communication device 402. Wireless device 402 is preferably a two-way communication device having at least voice and data communication capabilities, including the capability to communicate with other computer systems. Depending on the functionality provided by wireless device 402, it may be referred to as a data messaging device, a two-way pager, a cellular telephone with data messaging capabilities, a wireless Internet appliance, or a data communication device (with or without telephony capabilities).

If wireless device 402 is enabled for two-way communication, it will normally incorporate a communication subsystem 411, which includes a receiver 412, a transmitter 414, and associated components, such as one or more (preferably embedded or internal) antenna elements 416 and 418, local oscillators (LOs) 413, and a processing module such as a digital signal processor (DSP) 420. Communication subsystem 411 is analogous to RF transceiver circuitry 108 and antenna 110 shown in FIG. 1. As will be apparent to those skilled in field of communications, particular design of communication subsystem 411 depends on the communication network in which wireless device 402 is intended to operate.

Network access requirements will also vary depending upon type of network utilized. In GPRS networks, for example, network access is associated with a subscriber or user of wireless device 402. A GPRS device therefore requires a Subscriber Identity Module, commonly referred to as a “SIM” card 456, in order to operate on the GPRS network. Without such a SIM card 456, a GPRS device will not be fully functional. Local or non-network communication functions (if any) may be operable, but wireless device 610 will be unable to carry out any functions involving communications over the network.

When required network registration or activation procedures have been completed, wireless device 402 may send and receive communication signals over the network. Signals received by antenna 416 through the network are input to receiver 412, which may perform such common receiver functions as signal amplification, frequency down conversion, filtering, channel selection, and like, and in example shown in FIG. 4, analog-to-digital (A/D) conversion. A/D conversion of a received signal allows more complex communication functions such as demodulation and decoding to be performed in DSP 420. In a similar manner, signals to be transmitted are processed, including modulation and encoding, for example, by DSP 420. These DSP-processed signals are input to transmitter 414 for digital-to-analog (D/A) conversion, frequency up conversion, filtering, amplification and transmission over communication network via antenna 418. DSP 420 not only processes communication signals, but also provides for receiver and transmitter control. For example, the gains applied to communication signals in receiver 412 and transmitter 414 may be adaptively controlled through automatic gain control algorithms implemented in DSP 420.

Wireless device 402 includes a microprocessor 438 (which is one implementation of controller 106 of FIG. 1) which controls overall operation of wireless device 402. Communication functions, including at least data and voice communications, are performed through communication subsystem 411. Microprocessor 438 also interacts with additional device subsystems such as a display 422, a flash memory 424, a random access memory (RAM) 426, auxiliary input/output (I/O) subsystems 428, a serial port 430, a keyboard 432, a speaker 434, a microphone 436, a short-range communications subsystem 440, and any other device subsystems generally designated at 442. Some of the subsystems shown in FIG. 4 perform communication-related functions, whereas other subsystems may provide “resident” or on-device functions. Notably, some subsystems, such as keyboard 432 and display 422, for example, may be used for both communication-related functions, such as entering a text message for transmission over a communication network, and device-resident functions such as a calculator or task list. Operating system software used by microprocessor 438 is preferably stored in a persistent store such as flash memory 424, which may alternatively be a read-only memory (ROM) or similar storage element (not shown). Those skilled in the art will appreciate that the operating system, specific device applications, or parts thereof, may be temporarily loaded into a volatile store such as RAM 426. It is contemplated that the received communication signals, the detected signal log, and loss of contact log may also be stored to RAM 426.

Microprocessor 438, in addition to its operating system functions, preferably enables execution of software applications on wireless device 402. A predetermined set of applications which control basic device operations, including at least data and voice communication applications (such as a network re-establishment scheme), will normally be installed on wireless device 402 during its manufacture. A preferred application that may be loaded onto wireless device 402 may be a personal information manager (PIM) application having the ability to organize and manage data items relating to user such as, but not limited to, e-mail, calendar events, voice mails, appointments, and task items. Naturally, one or more memory stores are available on wireless device 402 and SIM 456 to facilitate storage of PIM data items and other information.

The PIM application preferably has the ability to send and receive data items via the wireless network. In a preferred embodiment, PIM data items are seamlessly integrated, synchronized, and updated via the wireless network, with the wireless device user's corresponding data items stored and/or associated with a host computer system thereby creating a mirrored host computer on wireless device 402 with respect to such items. This is especially advantageous where the host computer system is the wireless device user's office computer system. Additional applications may also be loaded onto wireless device 402 through network, an auxiliary I/O subsystem 428, serial port 430, short-range communications subsystem 440, or any other suitable subsystem 442, and installed by a user in RAM 426 or preferably a non-volatile store (not shown) for execution by microprocessor 438. Such flexibility in application installation increases the functionality of wireless device 402 and may provide enhanced on-device functions, communication-related functions, or both. For example, secure communication applications may enable electronic commerce functions and other such financial transactions to be performed using wireless device 402.

In a data communication mode, a received signal such as a text message or web page download will be processed by communication subsystem 411 and input to microprocessor 438. Microprocessor 438 will preferably further process the signal for output to display 422 or alternatively to auxiliary 1/0 device 428. A user of wireless device 402 may also compose data items, such as e-mail messages or short message service (SMS) messages, for example, using keyboard 432 in conjunction with display 422 and possibly auxiliary I/O device 428. Keyboard 432 is preferably a complete alphanumeric keyboard and/or telephone-type keypad. These composed items may be transmitted over a communication network through communication subsystem 411.

For voice communications, the overall operation of wireless device 402 is substantially similar, except that the received signals would be output to speaker 434 and signals for transmission would be generated by microphone 436. Alternative voice or audio I/O subsystems, such as a voice message recording subsystem, may also be implemented on wireless device 402. Although voice or audio signal output is preferably accomplished primarily through speaker 434, display 422 may also be used to provide an indication of the identity of a calling party, duration of a voice call, or other voice call related information, as some examples.

Serial port 430 in FIG. 4 is normally implemented in a personal digital assistant (PDA)-type communication device for which synchronization with a user's desktop computer is a desirable, albeit optional, component. Serial port 430 enables a user to set preferences through an external device or software application and extends the capabilities of wireless device 402 by providing for information or software downloads to wireless device 402 other than through a wireless communication network. The alternate download path may, for example, be used to load an encryption key onto wireless device 402 through a direct and thus reliable and trusted connection to thereby provide secure device communication.

Short-range communications subsystem 440 of FIG. 4 is an additional optional component which provides for communication between wireless device 402 and different systems or devices, which need not necessarily be similar devices. For example, subsystem 440 may include an infrared device and associated circuits and components, or a Bluetooth™ communication module to provide for communication with similarly-enabled systems and devices. Bluetooth™ is a registered trademark of Bluetooth SIG, Inc.

Wireless device 402 includes a battery interface 464 (such as that described in relation to FIG. 1) for receiving one or more rechargeable batteries. Such a battery provides electrical power to most if not all electrical circuitry in wireless device 402, and battery interface 464 provides for a mechanical and electrical connection for it. Battery interface 464 is coupled to a regulator 450 which regulates power to communication subsystem 411. Battery interface 464 is also coupled to a separate regulator 458 which regulates power to a SIM interface 454 of wireless device 402, as well as to most of the remaining circuitry of wireless device 402 (e.g. microprocessor 438, display 422, keyboard 432, etc.). Data and control lines 460 extend between SIM interface 454 and microprocessor 438 for communicating data therebetween and for control.

The above described electrical configuration for wireless device 402 may be used to operate wireless device 402 as follows. In a first operational state of wireless device 402, wireless device 402 is fully operative where regulators 450 and 458 are enabled and supply power to communication subsystem 411 and SIM interface 454, respectively. In a second operational state of wireless device 402, wireless device 402 is only partially operative where regulator 450 is disabled by microprocessor 438 so that communication subsystem 411 is powered off or shut down. No wireless or RF communication is possible in the second operational state, but wireless device 402 consumes less power compared to the first operational state. However, regulator 458 continues to operate and supply power to SIM interface 454, as well as to microprocessor 438 and the user interface. In response to an end user request through the user interface, information stored on SIM 456 is retrieved by microprocessor 438 using data and control lines 460, and the information is displayed on display 422. In a non-operational state of wireless device 402, (most if not) all electrical circuitry of wireless device 402 including communication subsystem 411, SIM interface 454, and microprocessor 438 are powered down. The above operation of wireless device 402 is described in more detail later in relation to FIG. 5.

In an alternate embodiment to that shown and described in relation to FIG. 4, regulator 450 is used to regulate power to communication subsystem 411 and regulator 458 is used to regulate power to SIM interface 454, controlled by microprocessor 438 as described herein. However, a third regulator different from regulators 450 and 458 is used to regulate power to microprocessor 438. This provides for optimal selective control over different portions of wireless device 402 as needed.

FIG. 5 is a state transition diagram for a wireless communication device, such as the wireless device described in relation to FIG. 1 or FIG. 4. The wireless communication device has at least three operating modes or states: a state 502, a state 504, and a state 506. State 502 is an “RF operable and SIM available” state; state 504 is an “RF inoperable but SIM available” state; and state 506 is a “fully inoperable” state.

In state 502 of FIG. 5 (“RF operable and SIM available” state), the wireless device may be perceived as being completely turned ON. RF transceiver circuitry of the wireless device (e.g. RF transceiver circuitry 108 of FIG. 1 or communication subsystem 411 of FIG. 4) is operable and available to wirelessly receive and/or transmit information through the wireless communication network. Although the RF transceiver circuitry is indeed operable and active in state 502, it may be placed into regular or periodic “sleep” modes by the controller or microprocessor in order to conserve power, in accordance with well-known techniques. In state 502, the SIM interface of the wireless device is also operable and enabled at least so that information stored on the SIM may be retrieved for display on a visual display of the wireless device when an end user requests it. The microprocessor is also generally enabled in state 502; for example, user input signals from the user interface may be detected by the microprocessor and information from the SIM may be transferred to the visual display by the microprocessor in response.

In state 506 of FIG. 5 (“fully inoperative” state), the wireless device may be perceived as being completely turned OFF. The RF transceiver circuitry is inoperable and unavailable to wirelessly receive and/or transmit information through the wireless network. The RF transceiver circuitry is not in a conventional “sleep mode” in state 506 and will not “wake up” to receive wireless signals and/or information through the wireless network or in response to most user input from the user interface. In state 506, the SIM interface is also completely disabled and no information from the SIM may be retrieved for display. The microprocessor is also generally inoperative in state 506.

In state 504 of FIG. 5 (“RF inoperable but SIM available” state), the RF transceiver circuitry is inoperable and unavailable to wirelessly receive and/or transmit information through the wireless network. The RF transceiver circuitry is not in a conventional “sleep mode” in this state 504 and will not automatically “wake up” to receive wireless signals and/or information through the wireless network. However, the SIM interface is operable and enabled at least so that information stored on the SIM may be retrieved for display on a visual display of the wireless device when an end user requests it. The microprocessor is also operative and generally enabled in this state 504, at least so that user input signals through the user interface may be detected and so that information from the SIM may be transferred to the visual display when the end user requests it.

When in state 506 (“fully inoperable” state), the wireless device may be placed into state 502 (“RF operable and SIM available” state) through a transition event 510 which may be a “Power ON signal” detected from the user interface. On the other hand, when in state 502 (“RF operable and SIM available” state), the wireless device may be placed into state 506 (“fully inoperable” state) through a transition event 512 which may be a “Power OFF signal” detected from the user interface. When in state 506 (“fully inoperable” state), the wireless device may be placed into state 504 (“RF inoperable but SIM available” state) through a transition event 514 which may be a “Partial Power ON” signal (different from the “Power ON signal”) detected from the user interface. On the other hand, when in state 504 (“RF inoperable but SIM available” state), the wireless device may be placed into state 506 (“fully inoperable” state) through a transition event 516 which may be the “Power OFF signal”. When in state 504 (“RF inoperable but SIM available” state), the wireless device may be placed into state 502 (“RF operable and SIM available” state) through a transition event 518 which may be the “Power ON signal”. On the other hand, when in state 502 (“RF operable and SIM available” state), the wireless device may be placed into state 504 (“RF inoperable but SIM available” state) through a transition event 516 which may be a “Partial Power OFF signal” detected from the user interface.

Conventionally, an end user is prompted for a password or PIN stored on the SIM and transition event 510 occurs only if the end user successfully enters the password or PIM through the user interface. Using an additional security measure, in response to receiving the “Partial Power ON” signal in state 506, the microprocessor may prompt the end user (through the user interface, e.g. the visual display) for the password or PIN stored on the SIM. Here, transition event 514 occurs only if the end user successfully enters the password or PIN (i.e. a match exists between the entered password or PIN and the stored password or PIN). In addition, in response to receiving the “Power ON” in state 504, the microprocessor may also prompt the end user for the password or PIN of the SIM and transition event 518 occurs only if the end user successfully enters it (i.e. a match exists between the entered password or PIN and the stored password or PIN).

FIG. 6 is a flowchart for describing a method of controlling power to electrical circuitry of a wireless communication device having an interface for a smart card (e.g. a SIM card). These methods may be employed in components shown and described above in relation to FIGS. 1-4. FIG. 6 relates to a method employed by a wireless communication device initially operating in a fully powered state (e.g. state 502 of FIG. 5). Beginning at a start block 602, the wireless device monitors its user interface to detect whether a (partial) power-off signal has been received (step 604). If not received, it continues monitoring the user interface. If the power-off signal is detected as tested in step 604, the wireless device (e.g. its microprocessor) powers OFF the RF transceiver circuitry of the wireless device (step 606). Even after detecting this power-off signal, however, the wireless device maintains power to the Subscriber Identity Module (SIM) interface (step 608).

Step 606 may be performed utilizing a regulator for the RF transceiver circuitry which is disabled or powered-off by the microprocessor in response to detecting the power-off signal (e.g. see FIG. 1 or FIG. 4). On the other hand, step 608 may be performed utilizing a regulator for the SIM interface (separate from the regulator for the RF transceiver circuitry) which is kept enabled or powered on by the microprocessor even after detecting the power-off signal (e.g. see FIG. 1 or FIG. 4). After step 608, the wireless device may be perceived as being in state 504 of FIG. 5 where it can be used to retrieve information stored on the SIM (e.g. address book information, SMS messages, PIM data, or any other suitable information) for display in the visual display.

In this state, the wireless device may monitor its user interface to detect whether a power-on signal has been received. If the power-on signal is detected in this state, the wireless device (e.g. its microprocessor) powers ON the RF transceiver circuitry while maintaining power to the SIM interface. In alternate embodiment, the wireless device monitors its user interface to detect whether a power-on signal has been received and, if detected, prompts the end user (through the user interface, e.g. the visual display) for a password or PIN of the SIM. In response, the end user enters a password or PIN and, if it matches the stored password or PIN of the SIM, then the wireless device (e.g. its microprocessor) powers ON the RF transceiver circuitry while maintaining power to the SIM interface.

The above-described embodiments of invention are intended to be examples only. Further alterations, modifications, and variations may be effected to particular embodiments by those of skill in art without departing from scope of invention, which is defined solely by claims appended hereto. For example, additional regulators may be utilized to separately regulate and/or control other portions of circuitry in the wireless device as desired. As another example, additional operational states or modes of the wireless device may be employed to further refine the operation of wireless device as desired.

What is claimed is:

1. A method of controlling power to electrical circuitry of a battery-powered wireless communication device, the method comprising the further acts of:
receiving a power-off signal from a user interface of the wireless communication device;
powering down radio frequency (RF) transceiver circuitry of the wireless communication device in response to the power-off signal; and
maintaining power to a smart card interface of the wireless communication device when the RF transceiver circuitry is powered down from the power-off signal.

2. The method of claim 1, comprising the further acts of:
receiving a power-on signal from the user interface;
prompting for a password or PIN of a smart card in response to receiving the power-on signal; and
powering on the RF transceiver circuitry after receiving the power-on signal.

3. The method of claim 1, comprising the further acts of:
receiving information through the RF transceiver circuitry;
operating the smart card interface to store the information on a smart card; and
retrieving the information when the RF transceiver circuitry is powered down from the power-off signal.

4. The method of claim 1, wherein the user interface circuitry comprises at least one of a keypad and a visual display, the method comprising the further acts of:
receiving information through the RF transceiver circuitry;
operating the smart card interface to store the information on a smart card;
retrieving the information through the smart card interface when the RF transceiver circuitry is powered down from the power-off signal; and
visually displaying the information on the visual display when the RF transceiver circuitry is powered down from the power-off signal.

5. The method of claim 1, wherein the user interface circuitry comprises at least one of a keypad and a visual display, the method comprising the further acts of:
receiving address book information through the RF transceiver circuitry;
operating the smart card interface to store the address book information on a smart card;
retrieving the address book information through the smart card interface when the RF transceiver circuitry is powered down from the power-off signal; and
visually displaying the address book information on the visual display when the RF transceiver circuitry is powered down from the power-off signal.

6. The method of claim 1, wherein the smart card interface comprises a Subscriber Identity Module (SIM) interface for a SIM.

7. A wireless communication device, comprising:
user interface circuitry;
radio frequency (RF) transceiver circuitry;
microprocessor circuitry;
a smart card interface;
the user interface circuitry configured to receive a power down signal;
the RF transceiver circuitry configured to be powered down in response to the power down signal; and
the smart card interface configured to be maintained with power while the RF transceiver circuitry is powered down from the power down signal.

8. The wireless communication device of claim 7, wherein the user interface circuitry comprises a keyboard or keypad.

9. The wireless communication device of claim 7, wherein the user interface circuitry comprises a visual display.

10. The wireless communication device of claim 7, wherein a smart card connected to the smart card interface comprises memory for storing information received through the RF transceiver circuitry.

11. The wireless communication device of claim 7, further comprising:
memory of a smart card which stores information received through the RF transceiver circuitry; and
the user interface comprising a visual display which displays the information while the RF transceiver circuitry is powered down from the power down signal.

12. The wireless communication device of claim 7, further comprising:
a battery interface which receives one or more batteries for powering the user interface circuitry, the RF transceiver circuitry, and the smart card interface.

13. The wireless communication device of claim 7, further comprising:
a first regulator coupled to the RF transceiver circuitry; and
a second regulator coupled to the smart card interface.

14. The wireless communication device of claim 7, further comprising:
a first regulator coupled to the RF transceiver circuitry;
a second regulator coupled to the smart card interface; and
a third regulator coupled to the microprocessor circuitry.

15. The wireless communication device of claim 7, wherein the smart card interface comprises a Subscriber Identity Module (SIM) interface.

16. The wireless communication device of claim 7, wherein the smart card interface comprises a Universal Mobile Telecommunications Standard (UMTS) card interface.

17. The wireless communication device of claim 7, further comprising:
the user interface circuitry configured to receive a power-on signal;
the user interface circuitry configured to prompt for a password or PIN of a smart card in response to receiving the power-on signal; and
the RF transceiver circuitry configured to be powered on after receiving the power-on signal.

18. The wireless communication device of claim 7, comprising a mobile station operable in a cellular telecommunication network.

19. The wireless communication device of claim 7, comprising a text message receiving device operable in a cellular telecommunication network.

20. A battery-powered wireless communication device, comprising:
radio frequency (RF) transceiver circuitry operative in accordance with General Packet Radio Service (GPRS) communication;
the RF transceiver circuitry configured to receive user information over an RF link;
a Subscriber Identity Module (SIM) interface for a SIM which stores the user information received through the RF transceiver circuitry;
user interface circuitry configured to receive a power-off signal;
the RF transceiver circuitry configured to be powered off in response to the power-off signal;
the SIM interface configured to be maintained with power while the RF transceiver circuitry is powered off from the power off signal;
the user interface circuitry configured to receive user input signals while the RF transceiver circuitry is powered off; and
microprocessor circuitry configured to retrieve the user information through the SIM interface in response to the user input signals, so that the user information is visually displayed in the visual display while the RF transceiver circuitry is powered off.

21. The battery-powered wireless communication device of claim 20, further comprising:
a first regulator circuit coupled to the RF transceiver circuitry; and
a second regulator circuit coupled to the SIM interface.

22. The battery-powered wireless communication device of claim 20, further comprising:
a first regulator circuit coupled to the RF transceiver circuitry;
a second regulator circuit coupled to the SIM interface; and
a third regulator circuit coupled to the microprocessor circuitry.
